(19) United States
(12) Patent Application Publication
(10) Pub. No.: US 2026/0148079 A1
(43) Pub. Date: May 28, 2026

(54) ASSESSMENT OF ANNOTATIONS OF GENERATED OUTPUTS

(71) Applicant: NVIDIA Corporation, Santa Clara, CA (US)

(72) Inventors: Julien Veron Vialard, San Francisco, CA (US); Jesse Oliver, British Columbia (CA); Suseella Panguluri, Dublin, CA (US); Nikhil Srihari, Bothell, WA (US); Nik Spirin, Redwood City, CA (US); Julianna Schneider, Santa Clara, CA (US)

(21) Appl. No.: 18/959,124

(22) Filed: Nov. 25, 2024

(51) Int. Cl. G06N 3/091

(52) U.S. Cl. CPC G06N 3/091

(57) ABSTRACT

Embodiments of the present disclosure relate to applications, platforms, architecture, etc. for assessing annotations generated by annotators in the evaluation of generated outputs. In particular one or more of a first ground truth annotation or a second ground truth annotation corresponding to one or more generated outputs may be obtained. The first ground truth annotation may be based at least on a plurality of assessment annotations and the second ground truth annotation may correspond to an expert related to the one or more generated outputs. Further, one or more assessments related to one or more assessment annotations of the plurality of assessment annotations may be determined based at least on one or more of the first ground truth annotation or the second ground truth annotation. In addition, one or more annotator adjustment operations may be performed based at least on the one or more assessments.

### BACKGROUND

In some instances, annotators (human and/or machine) may be used to provide annotations with respect to various types of modalities and corresponding outputs. For example, the annotations may indicate quality determinations with respect to various types of outputs such as machine learning outputs, computer vision determinations, generated text, and/or generated media such as audio, video, images, etc. However, there is also difficulty in assessing how well annotators are able to rate and determine the quality of such outputs.

For instance, large language models (LLMs), vision language models (VLMs), and/or multi-modal language models (MMLMs) may be configured to receive prompts from users regarding any number of topics and the models provide a response to such prompts. The prompts may include requests to provide information related to a topic, to generate charts, images, videos, audio, papers, computer code, etc. However, the output of the language models may not necessarily be reliable or accurate. Further, it may not be readily apparent to a typical user whether the model output is reliable or accurate. Annotators and their corresponding annotations may accordingly be used to determine the quality of such language model (or other machine learning models type) outputs. However, there is also difficulty in assessing how well the annotators are able to rate and determine the quality of the language model outputs.

### SUMMARY

Embodiments of the present disclosure relate to a particular manner in which annotations of annotators corresponding to outputs (e.g., machine learning outputs, such as LLM/VLM/MMLM outputs) may be assessed. The manner in which the assessment is performed may be one that allows for computing systems to perform such an assessment in a quantifiable and reproducible manner. By contrast, many assessment techniques currently used may be on an ad-hoc basis, may be fairly subjective, and/or may not be objective and easily applied across multiple annotations made by one or more annotators.

In particular, as discussed in further detail in the present disclosure, multiple assessment annotations may be obtained. The assessment annotations may respectively correspond to one or more individual annotators. Further, in some instances, the assessment annotations may correspond to an output (e.g., a machine learning model output) and may indicate assessments provided by the annotators regarding one or more quality indicators with respect to the output.

In some embodiments, the assessment annotations may be used to generate a consensus ground truth annotation corresponding to the output. In these and other embodiments, one or more annotation assessments may include consensus annotation assessments determined with respect to the individual assessment annotations based on the consensus ground truth annotation. In these and other embodiments, consensus annotation assessments may be determined for each of one or more assessment annotations corresponding to a same annotator to determine a consensus annotator assessment as well. The consensus annotator assessments may provide indications with respect to the quality of the assessment annotations provided by the corresponding annotators.

Additionally or alternatively, one or more annotation assessments may be based on an expert ground truth annotation corresponding to the output. The expert ground truth annotation may include an annotation made by an annotator of the output who is an expert in the field corresponding to the output. By way of example, one or more of the annotation assessments may include corresponding expert annotation assessments determined with respect to the individual assessment annotations based on the expert ground truth annotation. The expert annotation assessments may be determined in a similar or analogous manner as the consensus annotation assessments based on comparisons between the individual assessment annotations and the expert ground truth annotation.

In these and other embodiments, one or more expert annotator assessments may be determined based on the expert assessments corresponding to assessment annotations corresponding to respective annotators. The determination of the expert annotator assessments may be similar to determining the consensus annotator assessments based on the consensus assessments.

In these and other embodiments, one or more of the annotation assessments for individual assessment annotations may be based on a combination of the corresponding consensus and expert annotation assessments. Additionally or alternatively, one or more of the annotator assessments may also be based on a combination of the corresponding consensus and expert annotator assessments.

The assessments (e.g., annotation assessments and/or annotator assessments) may provide a mechanism to determine which annotations and/or corresponding annotators may be more reliable than others. Such information may be used for better selections of annotations and/or annotators for determining the quality of outputs, such as ML outputs. Additionally or alternatively, such information may be used to better train and improve annotators-which may include human annotators and/or machine learning annotators (e.g., LLMs that are prompted to evaluate the ML output).

Further, the improvement in identifying quality annotators and/or annotations and/or in improving the quality of annotators and/or annotations helps to improve the technological field of machine learning models in general. In particular, without reliable annotations on the quality of ML output it may be very difficult to determine whether or how to improve the ML model that produced the ML output. Conversely, reliable annotations of the quality of ML outputs help allow for better training of the underlying models. As indicated herein, embodiments of the present disclosure provide a manner to determine which annotations and annotators may be more reliable than others in which such information plays an important part in the development of ML models for which the annotations are determined.

### BRIEF DESCRIPTION OF THE DRAWINGS

The present systems and methods for annotation assessment are described in detail below with reference to the attached drawing figures, wherein:

FIG. 1 illustrates an example environment related to assessment of annotations related to generated outputs, according to one or more embodiments of the present disclosure;

FIG. 2A illustrates an example process that may be performed to generate assessments related to annotations of generated outputs, according to one or more embodiments of the present disclosure;

FIG. 2B illustrates an example heatmap chart related to reliability metrics, according to one or more embodiments of the present disclosure;

FIG. 2C illustrates another example heatmap chart related to reliability metrics, according to one or more embodiments of the present disclosure;

FIG. 2D illustrates an example heat map chart for error directions, according to one or more embodiments of the present disclosure;

FIG. 2E illustrates another example heat map chart for error directions, according to one or more embodiments of the present disclosure

FIG. 3 is a flow diagram showing a method for generating assessments related to annotations, according to one or more embodiments of the present disclosure;

FIG. 4A is a block diagram of an example generative language model system suitable for use in implementing at least some embodiments of the present disclosure;

FIG. 4B is a block diagram of an example implementation in which the generative LM of FIG. 4A includes a transformer encoder-decoder, according to one or more embodiments of the present disclosure;

FIG. 4C is a block diagram of an example implementation in which the generative LM of FIG. 4A includes a decoder-only transformer architecture, according to one or more embodiments of the present disclosure;

FIG. 5 is a block diagram of an example computing device suitable for use in implementing one or more embodiments of the present disclosure; and

FIG. 6 is a block diagram of an example data center suitable for use in implementing one or more embodiments of the present disclosure.

### DETAILED DESCRIPTION

Systems and methods disclosed herein relate to automating assessments of annotations and annotators that generate such annotations. In particular, the present disclosure relates to creating a mechanism in which computing systems may assess annotations of generated outputs in which the annotations provide indications related to the outputs. The outputs may include machine learning outputs, vision determinations, generated text, generated media such as audio, video, images, behavior performed by autonomous or semi-autonomous systems, etc. and the annotations may correspond to evaluations as to quality of such outputs.

For example, a generative machine learning model (GML model)—such as a generative language model (e.g., large language model (LLM))—may generate an output based on one or more prompts provided to such model. The annotations may include evaluations with respect to the accuracy of the output, how well the output relates to or follows the prompts, etc.

The quality of the annotations with respect to how well the annotations evaluate the output may vary. For example, in some instances, one or more of the annotations may be generated by human annotators with varying levels of subjectivity, objectivity, expertise, experience, training, aptitude, etc. with respect to the subject matter of the generated outputs. Additionally or alternatively, one or more of the annotations may be generated by a machine learning (ML) model (e.g., a GLM) in which the quality of the corresponding annotations may be based on the quality of the training of the ML model.

As discussed in detail in the present disclosure, in some embodiments, systems and methods may relate to assessing annotations and corresponding annotators. The assessment methodology described in the present disclosure may allow for computing systems to consistently and objectively assess the annotations and corresponding annotators.

For example, multiple assessment annotations corresponding to a same output may be obtained. The obtained assessment annotations may be used to generate a consensus ground truth annotation corresponding to the output. For example, the most commonly found annotation value of the annotations may be used as the consensus ground truth. Additionally or alternatively, the annotation value that corresponds to the majority of the annotations may be used as the consensus ground truth annotation.

In these and other embodiments, one or more assessments of individual annotations (“annotation assessments”) may be consensus annotation assessments determined with respect to the individual assessment annotations based on the consensus ground truth annotation. For example, in some embodiments, the individual assessment annotations may be compared against the consensus ground truth annotation to determine how closely the individual assessment annotations match the consensus ground truth annotation to obtain the consensus annotation assessments for the respective assessment annotations.

In these and other embodiments, consensus annotation assessments may be determined for each of one or more annotations corresponding to a same annotator to determine a consensus annotator assessment as well. The consensus annotator assessments may provide indications with respect to the quality of the assessment annotations provided by the corresponding annotators.

Additionally or alternatively, one or more annotation assessments may be based on an expert ground truth annotation corresponding to the output. The expert ground truth annotation may include an annotation made by an annotator of the output who is an expert in the field corresponding to the output.

By way of example, one or more of the annotation assessments may include corresponding expert annotation assessments determined with respect to the individual annotations based on the expert ground truth annotation. The expert annotation assessments may be determined in a similar or analogous manner as the consensus annotation assessments based on comparisons between the individual annotations and the expert ground truth annotation.

In these and other embodiments, one or more expert annotator assessments may be determined based on the expert assessments corresponding to annotations corresponding to respective annotators. The determination of the expert annotator assessments may be similar to determining the consensus annotator assessments based on the consensus assessments.

In these and other embodiments, one or more of the annotation assessments for individual annotations may be based on a combination of the corresponding consensus and expert annotation assessments. Additionally or alternatively, one or more of the annotator assessments may also be based on a combination of the corresponding consensus and expert annotator assessments.

In some embodiments, the assessments may indicate an accuracy of the annotators and/or their corresponding annotations. For example, in some embodiments, multiple annotations corresponding to a particular annotator may be compared against the respective ground truth annotations (e.g., the consensus ground truth annotations and/or the expert ground truth annotations) corresponding to the annotations. The comparison may indicate how accurate the annotations are with respect to the ground truth annotations. Based on such comparisons, the annotator assessments and/or the individual annotations assessments may be given accuracy scores that respectively indicate an overall accuracy of the particular annotator and/or the individual accuracy of a given annotation.

Additionally or alternatively, the comparisons may indicate a reliability of the annotators with respect to consistency of their corresponding assessment annotations. For example, in some embodiments, respective distances between the annotations corresponding to a particular annotator and the corresponding ground truth annotations may be determined. The distances may indicate how close the annotations are from the ground truth but may also indicate a direction from the ground truth. Annotations that have a relatively high consistency in both distance and direction may indicate an overall consistency or “reliability” in the corresponding annotator in that the corresponding annotations may be based on consistent reasoning and/or may be predicted even in instances in which such annotations may not necessarily be very accurate. By contrast, annotations that have a relatively large amount of variance in distance and/or direction may indicate less reliability in that the annotations of such annotators may be hard to predict or may have various inconsistencies in reasoning associated therewith, etc.

In these and other embodiments, the systems and methods may relate to identification and/or selection of certain annotators based on corresponding annotator assessments. Additionally or alternatively, the systems and methods may relate to providing feedback based on the individual annotator assessments to improve future annotations by the annotators.

The identification and selection of better annotators and/or the improvement of annotators may help in improving the quality of the generation of outputs. For example, entities that use annotators to help with quality control of generated outputs may be able to better identify and/or select the annotators that may provide the highest quality annotations of the generated outputs. The higher quality annotations may help such entities identify which outputs and corresponding systems and/or methodologies used to produce such outputs may be improved. Additionally or alternatively, the higher quality annotations may help in identification of problematic aspects of the outputs, which may help indicate where and/or how to focus improvement on the systems and methodologies used to generate the outputs.

The systems and methods of the present disclosure may be implemented across a variety of different platforms that may generate any sort of applicable output and/or that may use annotations for improvement thereof. For example, the systems and methods may be used to improve software development in various environments, such as cybersecurity environments (e.g., NVIDIA X®'s LaunchPad), simulation environments (e.g., NVIDIAR®'s Drive SIM), software development kits (e.g., NVIDIAR®'s DriveWorks, NVIDIAR®'s Omniverse), software application toolkits (e.g., NVIDIAR®'s CUDA Toolkit), or any other suitable platform for which software may be developed and improved by improving annotations related to outputs produced by the software.

The systems and methods described herein may also be used for a variety of other purposes and implemented in a variety of other systems, by way of example and without limitation, for machine (e.g., robot, vehicle, construction machinery, warehouse vehicles/machines, autonomous, semi-autonomous, and/or other machine types) control, machine locomotion, machine driving, synthetic data generation, model training (e.g., using real, augmented, and/or synthetic data, such as synthetic data generated using a simulation platform or system, synthetic data generation techniques such as but not limited to those described herein, etc.), perception, augmented reality (AR), virtual reality (VR), mixed reality (MR), robotics, security and surveillance (e.g., in a smart cities implementation), autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets (e.g., using universal scene descriptor (USD) data, such as OpenUSD, and/or other data types), cloud computing, generative artificial intelligence (e.g., using one or more diffusion models, transformer models, etc.), and/or any other suitable applications.

Disclosed embodiments may be comprised in and/or be used to improve a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models—such as one or more large language models (LLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

Further, one or more embodiments of the present disclosure may relate to assessing behavior or outputs associated with ego-machines and/or components of the one or more ego-machines, which may include any applicable machine or system that is capable of performing one or more autonomous or semi-autonomous operations. Example ego-machines may include, but are not limited to, vehicles (land, sea, space, and/or air), robots, robotic platforms, etc. In the present disclosure, reference to an “autonomous machine” or “semi-autonomous machine” may include any machine (e.g., vehicle) that may be configured to perform one or more autonomous or semi-autonomous navigation or movement operations. As such, such machines may also include machines in which an operator is required or in which an operator may perform such operations as well.

In some instances and implementations, one or more ML models may be used and/or improved upon (e.g., trained) based on annotations of their corresponding outputs such that the assessment of the annotations and/or corresponding annotators may be used to improve the models themselves. In some embodiments, the ML models may be packaged as a microservice-such an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model (e.g., weights and biases). In some instances, such as where the machine learning model is small enough (e.g., has a small enough number of parameters), the model may be included within the container itself. In other examples—such as where the model is large—the model may be hosted/stored in the cloud (e.g., in a data center) and/or may be hosted on-premises and/or at the edge (e.g., on a local server or computing device, but outside of the container). In such embodiments, the model may be accessible via one or more APIs-such as REST APIs. As such, and in some embodiments, the machine learning models described herein may be deployed as an inference microservice to accelerate deployment of models on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications-such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

The embodiments of the present disclosure will be explained with reference to the accompanying figures. It is to be understood that the figures are diagrammatic and schematic representations of such example embodiments, and are not limiting, nor are they necessarily drawn to scale. In the figures, features with like numbers indicate like structure and function unless described otherwise.

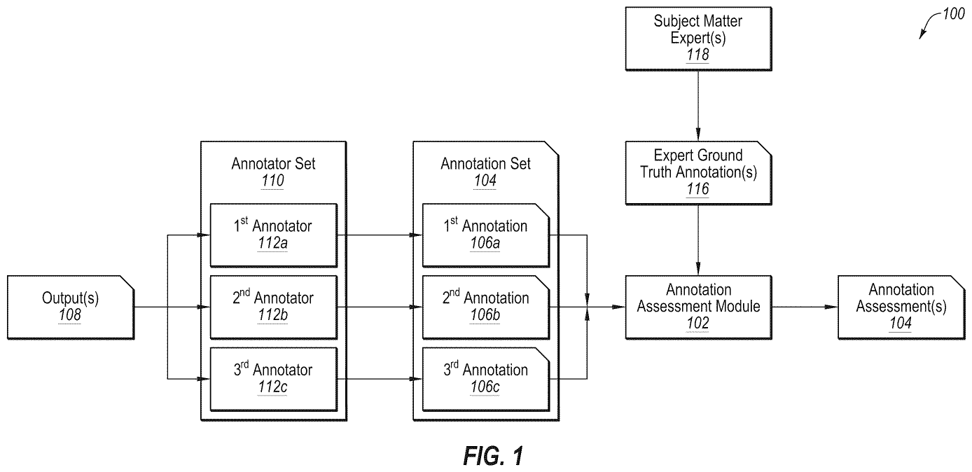

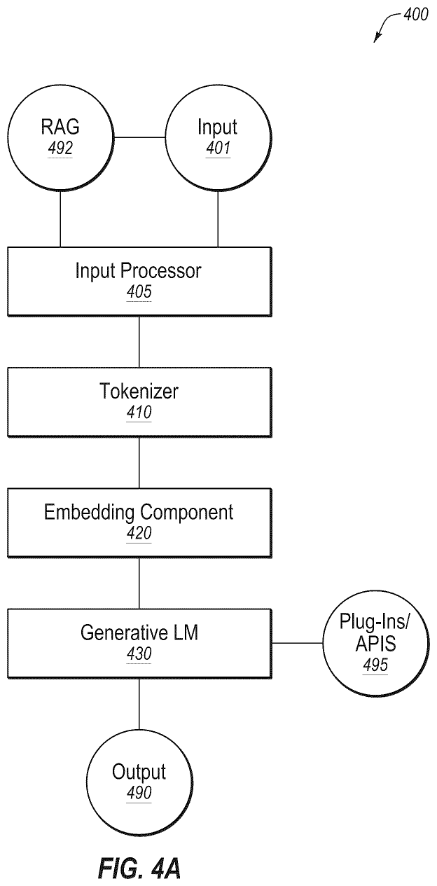

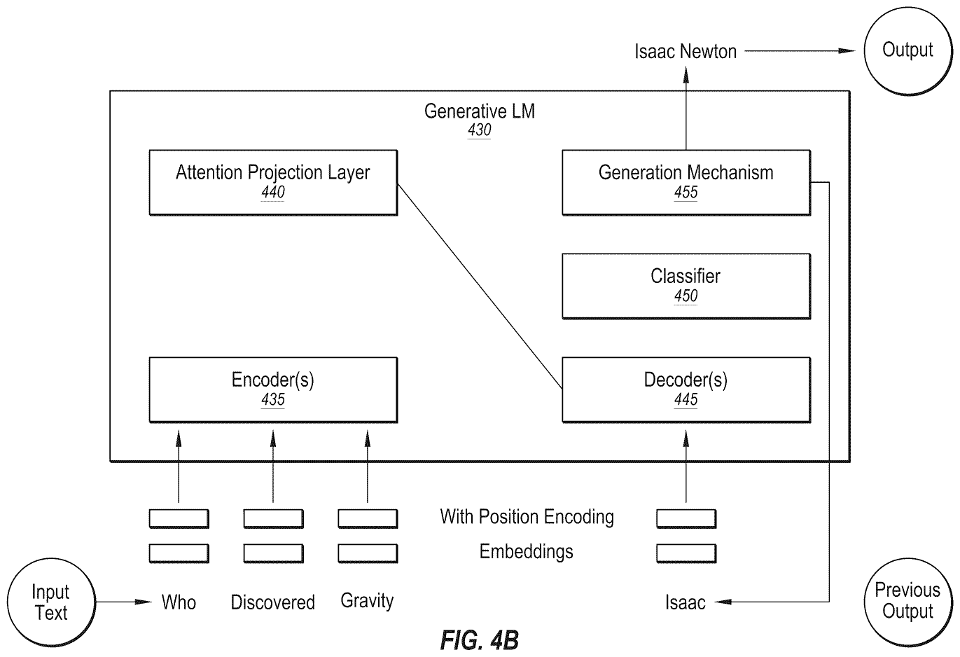

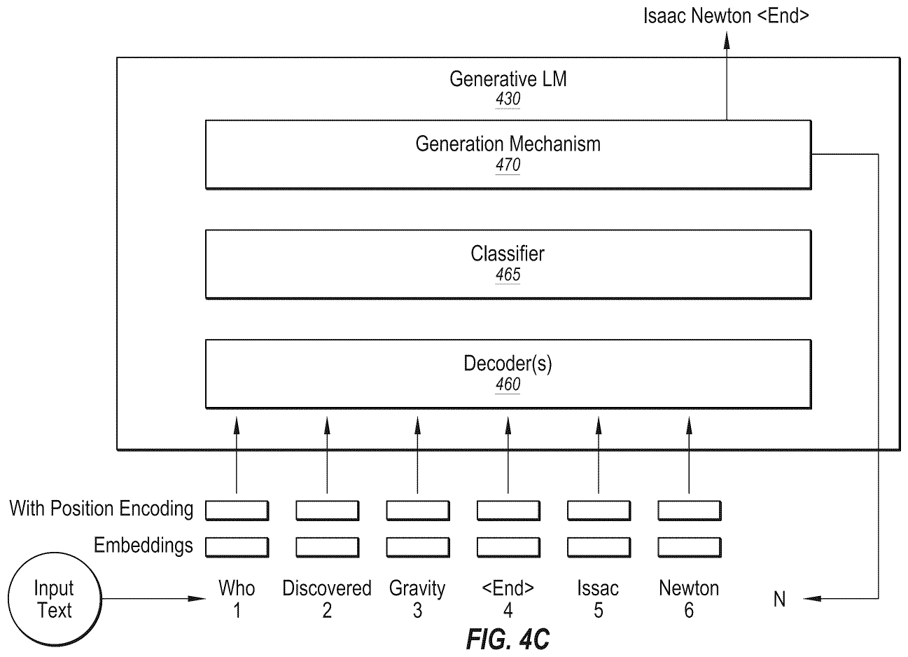

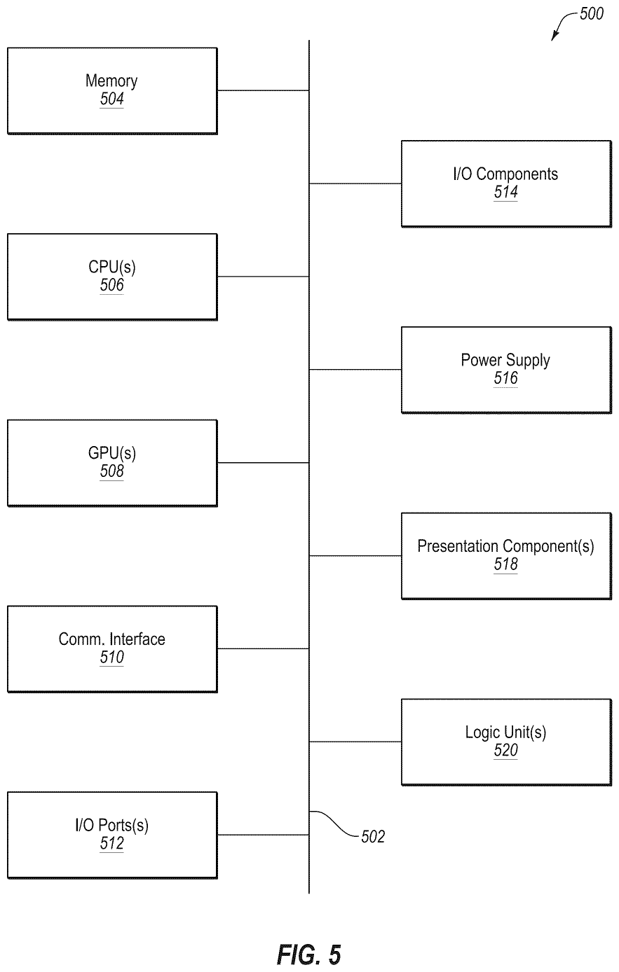

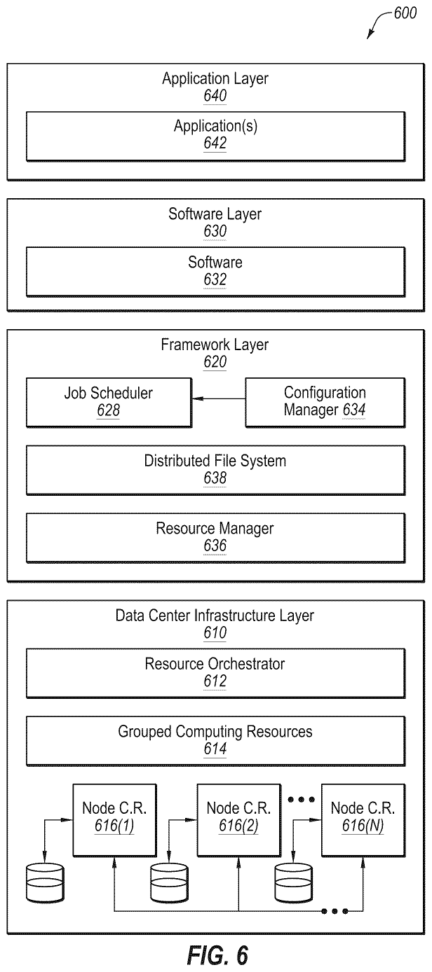

With reference to FIG. 1, FIG. 1 illustrates an example environment 100 related to assessment of annotations related to generated outputs, according to one or more embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. For example, in some embodiments, the system and methods described herein may be implemented using one or more generative language models (e.g., as described in FIGS. 4A-4C), one or more computing devices (e.g., as described in FIG. 5), and/or one or more data centers (e.g., as described in FIG. 6).

In general, the environment 100 may relate to assessing an annotation set 104. The annotation set 104 may include one or more annotations 106 corresponding to one or more outputs 108 that are designated for assessment (referred to generally in the present disclosure as “assessment annotations 106” or “annotations 106”).

The outputs 108 may include any suitable content that may be generated by a system, machine, person, etc. For example, the outputs 108 may include content such as generated text, generated images, generated video, generated audio, recorded behavior patterns etc. In these and other embodiments, the outputs 108 may be generated by any suitable ML model. For example, the one or more of the outputs 108 may be generated by a generative ML model such as the generative language models described as described in FIGS. 4A-4C of the present disclosure. Additionally or alternatively, one or more of the outputs 108 may include behavior patterns of autonomous and/or semi-autonomous machines. In these and other embodiments, one or more of the outputs 108 may be generated by a human.

In some embodiments, one or more of the outputs 108 may be generated based on certain inputs or prompts. For example, one or more of the outputs 108 may be generated by a GLM based on prompts provided to the GLM. Additionally or alternatively, one or more of the outputs may include answers to questions or responses to instructions provided by the GLM and/or to a human.

The assessment annotations 106 may include information related to the quality of the outputs 108. For example, the assessment annotations 106 may include ratings, rankings, evaluations, etc. indicating accuracy of an output 108 that is provided as a response to a question or instruction. In these and other embodiments, a particular set of assessment annotations 106 may correspond to an overall task related evaluating the output 108. Additionally or alternatively, the particular set of annotations 106 may include different annotation types with corresponding values that indicate how well the output 108 responds to the question or instruction and/or one or more other quality assessments.

For example, in instances in which a particular output 108 corresponds to text generated based on a particular instruction, one or more particular assessment annotations 106 corresponding to the task of evaluating the particular output 108 may include values related to coherence of the generated text, correctness of the generated text, verbosity of the generated text, helpfulness of the generated text, complexity of the generated text, and/or a preference ranking related to the generated text.

Individual assessment annotations 106 may respectively be generated by a respective annotator 112 of an annotator set 110. For example, a first annotator 112a of the annotator set 110 may generate one or more first assessment annotations 106a (“first annotations 106a”) such that the one or more first annotations 106a may correspond to the first annotator 112a. Similarly, a second annotator 112b of the annotator set 110 may generate one or more second assessment annotations 106b (“second annotations 106b”) such that the one or more second annotations 106b may correspond to the second annotator 112b. Additionally or alternatively, a third annotator 112c of the annotator set 110 may generate one or more third assessment annotations 106c (“third annotations 106c”) such that the one or more third annotations 106c may correspond to the third annotator 112c. Although illustrated and described as having three annotators 112, the annotator set 110 may include any number of annotators 112. Additionally or alternatively, the number of different sets of annotations 106 corresponding to different annotators 112 may vary depending on the number of different annotators 112. In these and other embodiments, the number of annotations 106 corresponding to individual annotators 112 may be the same across all of the annotators 112 or may be different between annotators 112.

The annotators 112 of the annotator set 110 may also be designated for assessment in some embodiments. Accordingly, in the present disclosure the annotators 112 may also be referred to as “assessment annotators”. In these and other embodiments, one or more of the annotators 112 may be human annotators. In these and other embodiments, one or more of the annotators 112 may be machine annotators (e.g., a GLM).

In some embodiments, the annotators 112 may generate the annotations 106 based on standardized annotation templates. For example, the standardized annotation templates may include a standardized set of criteria and/or instructions that may be provided to each annotator such that the different annotations 106 may be analyzed in an objective and quantifiable manner. In these and other embodiments, the standardized annotation templates may include standardized values that may be used as the annotation values.

For instance, referring to the example of generated text, the standardized annotation templates may include a numeric integer scale (e.g., from 1-5 or 1-10) that instructs the annotators 112 to provide a number on the scale with respect to each of coherence, correctness, verbosity, helpfulness, and complexity. Additionally or alternatively, multiple different outputs 108 corresponding to the same input instructions may be provided and the standardized annotation template may include a prompt for the annotators 112 to rank the different outputs 108 in general. In these and other embodiments, an individual output 108 may accordingly have multiple annotations 106 from a single annotator 112 associated therewith in which each annotation 106 may correspond to a different aspect of the individual output 108.

In some embodiments, the environment 100 may include an assessment module 102. In some embodiments, the assessment module 102 may include code and routines configured to cause performance of the operations described with respect to the assessment module 102. Additionally or alternatively, the assessment module 102 may be implemented using hardware including one or more processors, CPUs graphics processing units (GPUs), data processing units (DPUs), parallel processing units (PPUs), microprocessors (e.g., to perform or control performance of one or more operations), field-programmable gate arrays (FPGA), application-specific integrated circuits (ASICs), accelerators (e.g., deep learning accelerators (DLAs)), one or more programmable vision accelerators (PVAs), which may include one or more vector processing units (VPUs), one or more direct memory access (DMA) systems, one or more pixel processing engines (PPEs), etc., and/or other processor types. In these and other embodiments, the assessment module 102 may be implemented using a combination of hardware and software. In the present disclosure, operations described as being performed by the assessment module 102 may include operations that the assessment module 102 may perform itself or cause to be performed by another device. In some embodiments, the assessment module 102 may be implemented using one or more generative language models (e.g., as described in FIGS. 4A-4C), one or more computing devices (e.g., as described in FIG. 5), and/or one or more data centers (e.g., as described in FIG. 6).

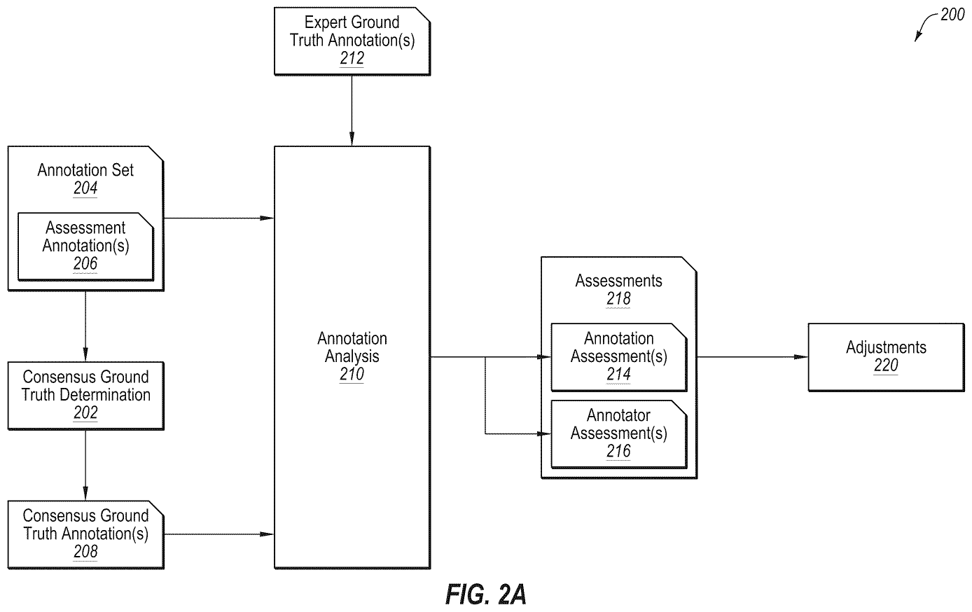

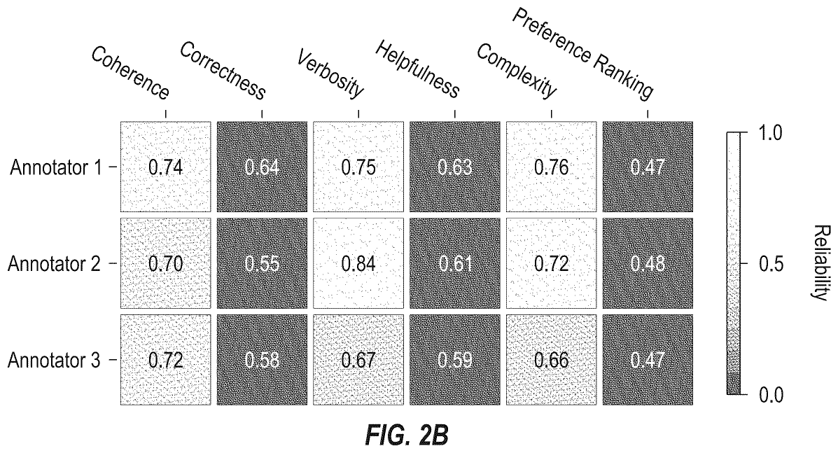

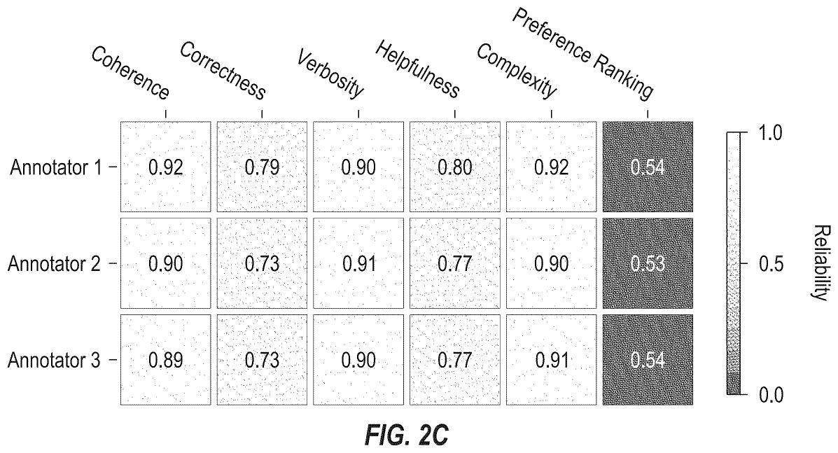

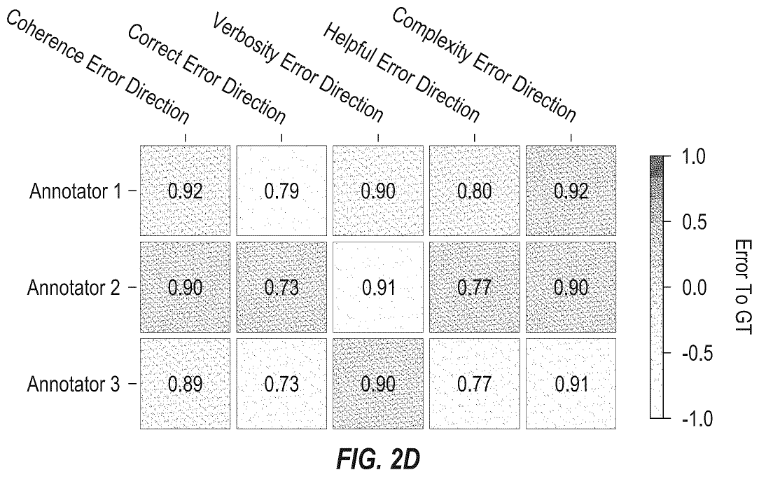

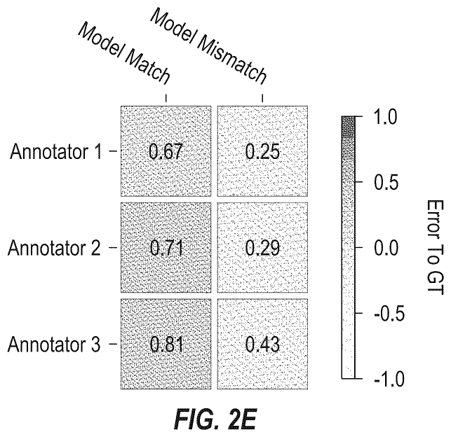

The assessment module 102 may be configured to generate one or more assessments 114 corresponding to the annotations 106. In general, the assessments 114 may provide indications related to the quality of one or more of the annotations 106 and/or the performance of one or more of the annotators 112 with respect to generation of quality annotations. In some embodiments, one or more of the assessments 114 may correspond to individual annotations 106 that respectively correspond to individual outputs 108. In these and other embodiments, one or more of the assessments 114 may correspond to individual annotators 112 with respect to their annotations corresponding to individual outputs 108. Additionally or alternatively, one or more of the assessments 114 may correspond to individual annotators 112 with respect to specific types of annotations 106 provided by the individual annotators 112 as determined based on annotations 106 of the same type that correspond to multiple different outputs 108. In these and other embodiments, one or more of the assessments 114 may correspond to the annotation set 104 as a whole with respect to one or more individual outputs 108. In some embodiments, the assessment module 102 may be configured to generate the assessments 114 according to one or more operations described with respect to FIG. 2A.

For example, as discussed in further detail in the present disclosure (e.g., with respect to FIG. 2A), in some embodiments, the assessment module 102 may be configured to determine one or more consensus ground truth annotations based on the annotations 106. In these and other embodiments, the assessment module 102 may be configured to generate one or more of the assessments 114 based on the consensus ground truth annotations.

Additionally or alternatively, the assessment module 102 may be configured to generate one or more of the assessments 114 based on one or more expert ground truth annotations 116. In some embodiments, the expert ground truth annotations 116 may be obtained to provide a reference standard for assessing the quality of the annotations 112. The expert ground truth annotations may be generated by one or more subject matter experts 118 who have specialized knowledge and experience relevant to the outputs 108 that are being annotated.

In some embodiments, the subject matter experts 118 may generate the expert ground truth annotations 116 according to predefined annotation guidelines and criteria. For example, in some embodiments, the subject matter experts 118 may be provided with the same respective standardized annotation templates that may be provided to the annotators 112 for the generation of the annotations 106.

The subject matter experts may review and analyze the outputs 108, applying their domain expertise to generate high-quality annotations that accurately reflect the desired assessment of the corresponding outputs 108. The expert annotations may be collected and aggregated by the assessment module 102 to establish the expert ground truth annotations 116. In some embodiments, if multiple experts provide annotations for the same output, the assessment module 102 may determine a consensus among the expert annotations, for example, in a similar manner that the consensus ground truth annotations from the annotations 106 may be determined.

The expert ground truth annotations may accordingly serve as a “gold standard” against which the annotations 106 may be compared and evaluated. By leveraging the specialized knowledge of subject matter experts, the expert ground truth annotations 116 may provide an authoritative reference point that captures nuanced assessments that may be challenging for non-expert annotators to consistently achieve. Further details regarding how the expert ground truth annotations 116 may be used to generate the assessments are given in the present disclosure, for example, as described with respect to FIG. 2A.

Modifications, additions, or omissions may be made to the environment 100 without departing from the scope of the present disclosure. For example, the number of elements and/or types of elements included in the environment 100 may vary depending on particular types of implementations. Further, as indicated, the types and/or number of outputs 108, the types and/or number of annotators 112, and/or the types and/or number of annotations 106 may vary depending on various implementations.

FIG. 2A illustrates an example process 200 that may be performed to generate assessments related to annotations of generated outputs, according to one or more embodiments of the present disclosure. One or more operation or block of the process 200 described herein, may comprise a computing process that may be performed using any combination of hardware, firmware, and/or software. For instance, various functions may be carried out by a processor executing instructions stored in memory. The process 200 may also be embodied as computer-usable instructions stored on computer storage media. The process 200 may be provided by a standalone application, a service or hosted service (standalone or in combination with another hosted service), as a microservice via an application programming interface (API) or a plug-in to another product, to name a few. In addition, the process 200 is described, by way of example, with respect to the environment of FIG. 1. However, the process 200 may additionally or alternatively be executed by any one system, or any combination of systems, including, but not limited to, those described herein.

In general, the process 200 may be configured to generate various assessments related to annotations 206 of an annotation set 204 that corresponds to one or more outputs. The annotation set 204 may be analogous to the annotation set 104 of FIG. 1 and the outputs may be analogous to the outputs 108 of FIG. 1 in some embodiments. Further, one or more of the assessments that are generated by the process 200 may be examples of one or more of the assessments 114 of FIG. 1.

Further, the operations of the process 200 are described in the context of being performed by a “system”. Such a system may include any suitable combination of hardware and/or software that may be configured to perform one or more of the operations of the process 200. For example, in some embodiments, the system may include one or more generative language models (e.g., as described in FIGS. 4A-4C), one or more computing devices (e.g., as described in FIG. 5), and/or one or more data centers (e.g., as described in FIG. 6).

In some embodiments the process 200 may include a consensus ground truth determination block 202 (“consensus determination 202”). The consensus determination 202 may include one or more operations related to determining a consensus with respect to annotations 206 that are of a same type, that correspond to a same output, and that also correspond to different annotators. The identified consensus may be used as a consensus ground truth annotation 208 for the corresponding annotation type and output. For example, the most commonly found annotation value of a particular annotation type with respect to a particular output may be used as the corresponding consensus ground truth annotation 208. Additionally or alternatively, the annotation value for the particular annotation type for the particular output that corresponds to the majority of the corresponding annotations may be used as the corresponding consensus ground truth annotation 208. In these and other embodiments, the average annotation value for the particular annotation type for the particular output may be used as the corresponding consensus ground truth annotation 208.

For instance, the annotation set 204 may include particular annotations 206 from multiple annotators that each correspond to the annotation type of “coherence” with respect to a particular output. Additionally or alternatively, the annotation values of the particular annotations 206 corresponding to “coherence” may be integer values on a scale from “1-5” in which “1” represents a very low degree of coherence and “5” represents a very high degree of coherence. In some embodiments, a particular consensus ground truth annotation 208 for the annotation type “coherence” for the particular output may be the most common integer value of the corresponding coherence annotations. Additionally or alternatively, the particular consensus ground truth for the annotation type “coherence” for the particular output may be the integer value that is included in the majority of the corresponding coherence annotations.

In some embodiments, the consensus determination 202 may be used to generate consensus ground truth annotations 208 for one or more of the different annotation types respectively corresponding to one or more of the outputs. In these and other embodiments, a consensus ground truth annotation 208 may be generated with respect to each annotation type of each output. Additionally or alternatively, a subset of consensus ground truth annotations 208 may be generated with respect to a subset of annotation types and/or a subset of respective outputs.

Further, in some embodiments, the annotations used to determine the consensus ground truth annotations 208 may be selected from certain sub-groups of corresponding annotators. In these and other embodiments, different consensus ground truth annotations 208 that correspond to the same output and same annotation type may be determined based on respective different sub-groups of corresponding annotators that are selected.

For example, in some instances, the annotations 206 of the annotation set 204 may include annotations from annotators corresponding to different annotation provider entities. In some embodiments, different consensus ground truth annotations 208 for the different annotation provider entities may be determined for the same annotation type and the same output. Additionally or alternatively, different consensus ground truth annotations 208 for different subgroups of annotators corresponding to the same annotation provider entity may be determined.

The process 200 may include an individual annotation analysis block 210 that includes one or more operations related to generating one or more assessments 218 based on one or more expert ground truth annotations 212 and/or the consensus ground truth annotation(s) 208. The expert ground truth annotations 212 may be analogous to the expert ground truth annotations 116 of FIG. 1 in some embodiments. The assessments 218 may include annotation assessments 214 and/or annotator assessments 216. The annotation assessments 214 may provide indications of the quality of individual annotations 206 with respect to corresponding expert ground truth annotations 212 and/or consensus ground truth annotations 208. In these and other embodiments, the annotator assessments 216 may provide indications of the quality of annotations 206 corresponding to individual annotators based on the annotation assessments 214 corresponding to the individual annotators. Additionally or alternatively, the annotator assessments 216 may provide collective indications of the quality of annotations 206 corresponding to groups of annotators based on the annotation assessments 214 corresponding to the collective group.

In some embodiments, the individual annotation analysis block 210 may include calculating various metrics to generate the individual assessments 218. For example, the individual annotation analysis block 210 may include calculating reliability metrics, accuracy metrics, error directions, and/or other metrics by comparing the annotations 206 to the expert ground truth annotations 212 and/or the consensus ground truth annotations 208. These metrics may be used to evaluate the quality and consistency of individual annotations 206 and/or their corresponding annotators. Further such metrics and quality and consistency determinations may be indicated by one or more individual annotation assessments 214 that correspond to individual annotations 214 and/or one or more individual annotator assessments 216 that correspond to individual annotators.

In some embodiments, the reliability metric determinations of the annotations 206 and of their annotators may be performed using various techniques. The reliability metric process may provide insights into the quality and consistency of annotations across different annotators and annotation tasks.

Various techniques may be used to calculate the reliability metrics. For example, in some embodiments, direct matching scores may be determined for individual annotations 206 by comparing the respective annotations 206 to one or more of the ground truth annotations (e.g., the expert ground truth annotations 212 and/or the consensus ground truth annotations 208). For example, the system may assign a direct matching score of “1.0” to a first annotation 206 in response to the first annotation 206 exactly matching a corresponding ground truth. Additionally or alternatively, the system may assign a direct matching score of “0.0” to a second annotation 206 in response to the second annotation 206 not exactly matching a corresponding ground truth.

In these and other embodiments, the system may determine one or more margin matching scores for individual annotations 206 by determining whether the annotations 206 are within a predefined range of a corresponding ground truth annotation (e.g., the expert ground truth annotations 212 and/or the consensus ground truth annotations 208). For example, for margin matching, the system may assign a margin matching score of “1.0” to annotations 206 that are within a particular distance of the corresponding ground truth in either direction (e.g., within one point in instances in which the annotation values are numerical integers), and 0.0 otherwise. The matching scores may be included in the annotation assessments 214 in some embodiments.

In some embodiments, multiple matching scores for individual annotations 206 may be determined. For example, an annotation consensus matching score may be determined for a particular annotation 206 based on a comparison with a corresponding consensus ground truth annotation 208. Additionally or alternatively, an annotation expert matching score may be determined for the particular annotation 206 based on a comparison with a corresponding expert ground truth annotation 212. In these and other embodiments, an aggregated annotation matching score may be determined for the particular annotation 206 based on a combination of the annotation consensus matching score and the annotation expert matching score. Additionally or alternatively, the annotation consensus matching score and/or the annotation expert matching score may be determined using direct matching and/or margin matching in some embodiments.

Additionally or alternatively, the consensus matching score and the expert matching score may be weighted the same or differently in the determination of the aggregated annotation matching score. For example, the expert matching score may be weighted more than the consensus matching score or vice versa. In these and other embodiments, the weighting may be based on respective levels of confidence of the consensus ground truth annotation 208 and the expert ground truth annotation 212 used in determining the consensus and expert matching scores.

In some embodiments, the system may calculate reliability metrics for individual annotators by aggregating (e.g., averaging) the matching scores of multiple annotations 206 corresponding to the annotators. In some embodiments, the reliability metrics for individual annotators may be included in the annotator assessments 216.

In some embodiments, the reliability metrics may be determined with respect to the annotations 206 that generally correspond to the different annotators. For example, the system may aggregate (e.g., average) multiple matching scores of multiple annotations 206 corresponding to a particular annotator (e.g., all the annotations 206 corresponding to the particular annotator) to generate a general reliability metric for the particular annotator.

Additionally or alternatively, the reliability metrics may be broken down with respect to different types of annotations 206. For example, the matching scores for multiple annotations 206 corresponding to a same annotator for a same particular annotation type may be aggregated into a reliability metric for that annotator with respect to that annotation type. Additionally or alternatively, similar reliability metrics may be determined for the same annotator for different annotation types of annotations 206 generated by the annotator. This may result in reliability metrics for different annotation categories for the same annotator. For example, different reliability metrics such as coherence, correctness, verbosity, helpfulness, complexity, and preference ranking may be determined for individual annotators.

In these and other embodiments, the reliability metrics may be broken down according to annotation task. For example, the matching scores for multiple annotations 206 corresponding to the same annotator for a particular annotation task may be aggregated into a reliability metric for that annotator with respect to that annotation task. Additionally or alternatively, similar reliability metrics may be determined for the same annotator for different annotation tasks. This may result in reliability metrics for different annotation tasks for the same annotator.

In these and other embodiments, the system may calculate collective reliability metrics for groups of annotators by aggregating (e.g., averaging) the matching scores of multiple annotations 206 corresponding to the group of annotators. The collective reliability metrics may include general overall reliability metrics for the respective groups, reliability metrics broken down by annotation type, and/or reliability metrics broken down by annotation task. In some embodiments, the collective reliability metrics for groups of annotators may be included in the annotator assessments 216.

In some embodiments, the system may generate visualizations of the reliability metrics, such as tables and/or heatmaps that are color-coded according to predefined reliability standards. This may enable side-by-side comparisons of annotator performance across different categories and metrics.

For example, Table 1 below illustrates reliability metrics with respect to direct matching scores that have been determined with respect to annotations 206 corresponding to different annotators.

TABLE 1

| Annotator | Overall Direct Matching Reliability Metric |
|---|---|
| Annotator 1 | 0.79 |
| Annotator 2 | 0.71 |
| Annotator 3 | 0.74 |

As another example, Table 2 below illustrates different direct matching reliability metrics for the annotators of Table 1 for different annotation categories of coherence, correctness, verbosity, helpfulness, complexity, and preference ranking.

TABLE 2

| | | | | | | Preference |
|---|---|---|---|---|---|---|
| Annotator | Coherence | Correctness | Verbosity | Helpfulness | Complexity | Ranking |
| Annotator 1 | 0.735 | 0.640 | 0.75 | 0.63 | 0.760 | 0.47 |
| Annotator 2 | 0.700 | 0.545 | 0.84 | 0.61 | 0.720 | 0.48 |
| Annotator 3 | 0.725 | 0.580 | 0.67 | 0.59 | 0.655 | 0.47 |

As another example, Table 3 below illustrates different margin matching reliability scores for the annotators of Table 1 for the different annotation categories of coherence, correctness, verbosity, helpfulness, complexity, and preference ranking.

TABLE 3

| | | | | | | Preference |
|---|---|---|---|---|---|---|
| Annotator | Coherence | Correctness | Verbosity | Helpfulness | Complexity | Ranking |
| Annotator 1 | 0.920 | 0.790 | 0.90 | 0.795 | 0.920 | 0.54 |
| Annotator 2 | 0.895 | 0.735 | 0.91 | 0.770 | 0.895 | 0.53 |
| Annotator 3 | 0.885 | 0.730 | 0.90 | 0.765 | 0.905 | 0.54 |

Further, FIGS. 2B and 2C illustrate example heatmap charts corresponding to Tables 2 and 3, respectively. In FIGS. 2B and 2C, different shading levels indicate different levels of reliability.

In some embodiments, a tiered decision-making process between margin matching and direct matching may be implemented. For example, in instances in which direct matching scores are lower than expected, margin matching may provide a secondary tier for investigation. Additionally or alternatively, in instances in which scores do not improve between direct matching and margin matching, it may indicate the annotator pool is severely mis-annotating. In contrast, in instances in which there is improvement from direct matching to margin matching, it may indicate only slight adjustments are needed to turn successful margin matches into successful direct matches. This tiered approach using both strict and lenient matching criteria may provide more nuanced insight into annotator reliability and areas for potential improvement in the annotation process.

In some embodiments, the different reliability scores may also be used to determine an overall performance classification for the individual annotators. In these and other embodiments, the overall performance classifications may be included in the annotator assessments 216 By way of example, Table 4 below illustrates performance classifications in instances in which “1.0” is assigned for matching a ground truth.

TABLE 4

| Overall Reliability Score | Performance Classification |
|---|---|
| >0.8 | Pass |
| >0.7 | Marginal Fail |
| >0.6 | Fail |
| >0.5 | Critical Fail/Random Chance |

In some embodiments, the overall performance classifications may be based on direct matching and the tiered approach of using margin matching based determinations may be used in instances in which the performance classification is below a certain level (e.g., is not a “Pass”). In these and other embodiments, the margin matching may also be used to identify further understanding with respect to the degree of failure. Additionally or alternatively, performance classifications may be based on a combination of direct matching and margin matching in which additional information may be provided with respect to a certain classification. For example, the performance classification may include a primary classification that is based only on direct matching reliability scores and a secondary classification that is based on margin matching reliability scores.

In some embodiments, the system may calculate accuracy metrics that may also be included in the assessments 218. The accuracy metrics may correspond to individual annotations 206, sets of annotations 206 corresponding to a same task, and/or certain annotators. In these and other embodiments, the accuracy metrics may be based on and/or include the similar or same information as the reliability metrics. For example, in some embodiments direct matching and/or margin matching may be used to determine

For instance, the system may determine consider a particular annotation 206 to be “accurate” (or “true”) in response to such annotation matching (e.g., via direct matching and/or margin matching) a corresponding ground truth annotation (e.g., a corresponding consensus ground truth annotation 208 and/or a corresponding expert ground truth annotation 212). By contrast, the system may label the particular annotation 206 to be “inaccurate” (or “false”) in response to such annotation not matching (e.g., via direct matching and/or margin matching) the corresponding ground truth annotation. In these and other embodiments, such accuracy assessments may be included in the annotation assessments 214.

In these and other embodiments, the system may determine respective accuracy metrics for individual annotators. In some embodiments, the individual accuracy metrics for annotators may be included in the annotator assessments 216.

In these and other embodiments, the annotator accuracy metrics may include a general overall accuracy metric for a particular annotator. For example, the number of “accurate” and “inaccurate” annotations 206 corresponding to the same annotator may be analyzed to identify correspondences (e.g., percentages, ratios, total numbers, etc.) between accurate annotations and inaccurate annotations provided by the annotator in general. The correspondences may accordingly provide indications related to the overall accuracy of such annotator with respect to generation of annotations.

Additionally or alternatively, the annotator accuracy metrics may include an accuracy metric with respect to a particular annotator with respect to a particular annotation category. For example, the number of “accurate” and “inaccurate” annotations 206 corresponding to the same annotator and the same annotator type may be analyzed to identify correspondences (e.g., percentages, ratios, total numbers, etc.) between accurate annotations and inaccurate annotations for such a category and annotator. The correspondences may accordingly provide indications related to the overall accuracy of such annotator with respect to such annotation category.

Additionally or alternatively, the system may determine an accuracy metric with respect to a particular annotator with respect to a particular annotation task. For example, the number of “accurate” and “inaccurate” annotations 206 corresponding to the same annotator and the same annotation task may be analyzed to identify correspondences (e.g., percentages, ratios, total numbers, etc.) between accurate annotations and inaccurate annotations for such a task and annotator. The correspondences may accordingly provide indications related to the overall accuracy of such annotator with respect to such annotation task.

In these and other embodiments, the system may calculate collective accuracy metrics for groups of annotators by aggregating (e.g., averaging) the accuracy metrics of multiple annotations 206 corresponding to the group of annotators. The collective accuracy metrics may include general overall accuracy metrics for the respective groups, accuracy metrics broken down by annotation type, and/or accuracy metrics broken down by annotation task. In some embodiments, the collective accuracy metrics for groups of annotators may be included in the annotator assessments 216.

In some embodiments, the system may generate reports and/or visualizations with respect to the annotation accuracy assessments. For example, the system may generate tables, heatmaps, etc. that indicate different correspondences and indications regarding the number of “accurate” (or “true”) annotations 206 and the number of “inaccurate” (or “false”) annotations 206 as corresponding to different annotators, annotator groups, annotation categories, and/or annotation tasks.

In some embodiments, the process 200 may include an adjustment block 220 (“adjustment block 220”). With respect to the adjustment block 220, the system may perform one or more operations related to adjusting the annotations that may be generated by annotators. For example, feedback may be provided for the annotators that may be used to improve the annotations generated by the annotators. For example, for human annotators, feedback on their annotation performance and trends may be provided to help improve future annotations. Additionally or alternatively, for machine annotators, updated training may be performed and/or better prompt generation may be identified based on the feedback.

In these and other embodiments, with respect to the adjustment block 220, the system may perform one or more operations related to adjusting which annotators may be used in the generation of annotations. For example, the system may identify which annotators have corresponding performance metrics (e.g., accuracy and/or reliability metrics) that satisfy a certain threshold and/or that are better than those of other annotators. The system may select such annotators for future annotation tasks. In these and other embodiments, the selection may be based on certain task types, annotation types, etc. that may correspond to the future annotation tasks and for which selected annotators may perform well.

In some embodiments, the adjustment 220 may include determining error direction information indicating whether annotators tend to score above or below ground truth annotations. This information may be used to identify potential biases or systematic errors in the annotation process. For example, if an annotator consistently scores higher than the ground truth across multiple tasks, this may indicate a tendency to be overly generous in their assessments. Although discussed and illustrated on an individual annotator level, the error direction scores may be determined for groups of annotators collectively as well.

In some embodiments, the error direction determination may include tracking which side of an acceptable range an annotation 206 falls on and calculating weighted averages of the error directions. For example, the system may assign a score of −1.0 to annotations below a corresponding ground truth, 1.0 to annotations above the corresponding ground truth, and 0.0 to exact matches or annotations outside the acceptable range. These scores may then be averaged for the annotations 206 corresponding to individual annotators. In these and other embodiments, the averaging may include a weighted averaging that is based on the error size.

For example, the direction scores may be averaged for all annotations 206 corresponding to an individual annotator for a generalized error direction score for the annotator. Additionally or alternatively, the direction scores may be averaged for all annotations 206 corresponding to a particular annotation type and an individual annotator for an annotation type error direction score for the annotator for that annotation type. In these and other embodiments, the direction scores may be averaged for all annotations 206 corresponding to a particular annotation task and an individual annotator for an annotation task error direction score for the annotator.

In some embodiments, the error direction scores may be normalized to a range of −1 to 1. In these and other embodiments, the error direction scores may be and visualized using a chart, graph, table, diverging color map, etc. For example, FIG. 2D illustrates an example heat map chart for error directions related to the annotation types of coherence, correctness, verbosity, helpfulness, and complexity with respect to different annotators.

In some instances, matching scores in certain annotation types may obscure issues or the types of issues behind annotation errors. For example, margin matching in preference ranking may obscure the discrete difference between choosing one output over another. For example, if an annotator selects “Output 2 is slightly better than Output 1” but the ground truth is “Output 1 is slightly better than Output 2” these two cases should not margin match. Consequently, in some embodiments, the error direction scoring for such annotations 206 may be separated. For instance, for preference ranking annotations, the scoring may be separated into “Model Match” and “Model Mismatch” groups and error direction for such groups may be separately visualized within the groups. FIG. 2E illustrates and heat map chart for error directions related to such an approach.

In some embodiments, the error direction scores may be used to generate annotator feedback. For example, with respect to human annotators, the error direction scores may indicate to the human annotators tendencies in their annotation approach. Additionally or alternatively, the error direction scores may indicate a level of consistency in their approaches. The identification of tendencies and/or amount of consistency may indicate types of training that may be needed. Additionally or alternatively, the identification of tendencies and/or amount of consistency may also help in selecting which annotators and/or groups of annotators may be better suited for certain annotation tasks.

Additionally or alternatively, for machine annotators, the error direction scores may indicate blind spots, biases, holes, etc. in the training and/or prompting of such annotators. Such error direction analysis may accordingly help improve the machine annotators as well.

In these and other embodiments, the adjustment 220 may include adjusting the entities that generate the outputs that are being annotated. For example, annotations 206 with relatively high annotation assessments 214 and/or annotations 206 corresponding to annotators with relatively high annotator assessments 216 may be selected for use to provide feedback for the generation of the corresponding outputs. For instance, for ML based outputs, the selected annotations 206 may be used to improve training data, prompting, etc.

The process 200 may accordingly be used to improve and/or select annotators such that corresponding annotations 206 for outputs may be improved. The improvement of the annotations may be used to improve the techniques, systems, etc., that produce such outputs, which may help improve the technological fields (e.g., machine learning) corresponding to such outputs.

Further, as indicated in the present disclosure, one or more of the annotators may be machine annotators (e.g., GLMs). The assessment of the annotations generated by such machine annotators and the corresponding annotator adjustment of the process 200 may accordingly improve the machine annotators themselves.

For instance, in some embodiments, one or more machine annotators may include GLMs that operate as judges between multiple outputs (e.g., that perform preference scoring). The following is an example description of operations that may be performed with respect to the process 200 in the context of assessing the annotations of the GLMs as judges with respect to analyzing outputs that include conversations between an user and an AI assistant in which the GLMs are judging the quality of the AI assistant responses. In the present disclosure, the conversations may be referred to as including one or more “turns” which may correspond to individual requests by the users and corresponding responses by the AI assistant.

In some implementations, one or more reliability metrics (e.g., such as described with respect to the assessments 218) for a pool of GLM annotators may be determined. The reliability metrics may indicate how reliably each GLM annotator matches a corresponding ground truth (e.g., an expert ground truth annotation 212) across multiple conversation turns between the user and the AI assistant. This may provide insight into the consistency and accuracy of the GLM annotator pool throughout the course of a full conversation between the user and the AI assistant.

Additionally, the process 200 may be used to calculate one or more accuracy metrics for the GLMs by comparing annotations of the GLMs to the ground truth annotations (e.g., such as described with respect to the assessments 218). This may involve scoring accuracy for overall model preferences as well as turn-by-turn assessments.

For example, in some embodiments, the accuracy metrics may be determined for overall conversation types by averaging the accurate and inaccurate annotations across multiple tasks to produce overall accuracy scores that may be related to different categories and/or domains. For instance, Table 5 below illustrates an overall accuracy score for a particular GLM (“GLM 1”) as a judge with respect to all annotations generated by the particular GLM in which a score of “1.0” indicates perfect accuracy and a score of “0.0” indicates complete inaccuracy. Additionally,

TABLE 5

| GLM Judge | Overall Accuracy as Judge |
|---|---|
| GLM 1 | 0.552632 |

Table 6 below illustrates different accuracy scores for GLM 1 operating as a judge across different conversation type categories using the same scoring methodology as Table 5.

TABLE 6

| Category | Accuracy |
|---|---|
| Overall | 0.552632 |
| Brainstorm | 0.388889 |
| Chat Completion | 0.833333 |
| Chat-Multiturn | 0.648148 |
| Closed QA | 0.138889 |
| Generation | 0.141667 |
| Open QA | 0.666667 |
| Rewrite | 0.633333 |
| Summarization | 0.333333 |

Table 7 below illustrates different accuracy scores for GLM 1 operating as a judge across different subject matter domains using the same scoring methodology as Table 5.

TABLE 7

| Domain | Accuracy |
|---|---|
| Overall | 0.552632 |
| Creative | 0.416667 |
| General Business | 0.583333 |
| General Reasoning | 0.416667 |
| Language Understanding | 0.500000 |
| Legal | 0.833333 |
| Math and Logic | 0.481481 |
| Safety and Adversarial | 0.625000 |

In these and other embodiments, accuracy metrics may be determined for individual and/or groups of GLMs on a turn-by-turn basis with respect to multiple turns of the same type. Additionally or alternatively, one or more tables and/or other visualizations may be generated to illustrate the turn-by-turn accuracy metrics.

The accuracy metrics may reveal trends in GLM annotator performance that may be used to guide further prompt engineering and improvements for the GLM annotator and/or the AI assistant. In some embodiments, a small subset of human validation samples (e.g., expert ground truth annotations 208) to calibrate and monitor GLM annotator performance. This may allow for cost-effective scaling of large annotation initiatives while maintaining quality control. The reliability and accuracy metrics generated for the GLMs may help identify specific categories or areas where the GLMs may require adjustment or additional prompt engineering to better approximate human expert judgments.

As indicated prior, the assessment of GLMs as judges may be integrated into the broader annotation assessment described herein. This may allow for comprehensive evaluation of both human and GLM annotators using consistent metrics and visualizations. The combined system may provide a robust framework for assessing annotation quality, reliability, and accuracy across diverse annotation tasks and annotator types.

Modifications, additions, or omissions may be made to the process 200 without departing from the scope of the present disclosure. For example, although illustrated as discrete blocks or operations, various blocks or operations of the process 200 may be divided into additional blocks, combined into fewer blocks, or eliminated, depending on the particular implementations. Further, in some embodiments, one or more of the operations may be combined into fewer operations or expanded out to include additional operations.

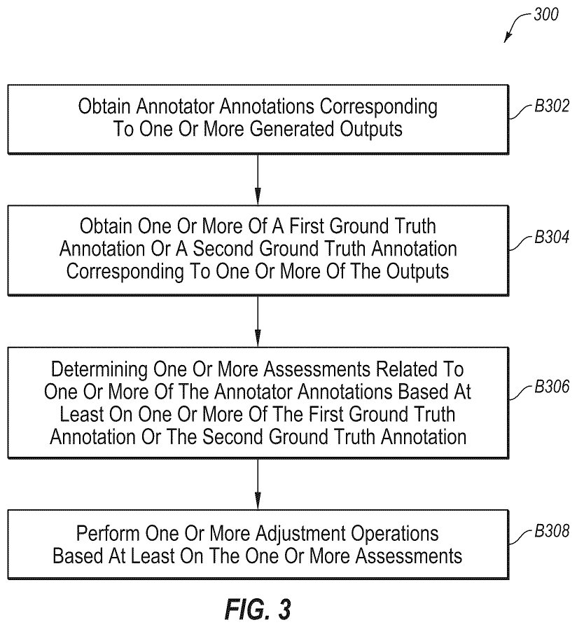

Now referring to FIG. 3, each block of method 300, described herein, comprises a computing process that may be performed using any combination of hardware, firmware, and/or software. For instance, various functions may be carried out by a processor executing instructions stored in memory. The method 300 may also be embodied as computer-usable instructions stored on computer storage media. The method may be provided by a standalone application, a service or hosted service (standalone or in combination with another hosted service), as a microservice via an application programming interface (API) or a plug-in to another product, to name a few. One or more operations of the method 300 may be performed, by way of example, by one or more elements of the environment of FIG. 1, the computing device of FIG. 5, and/or the data center of FIG. 6. However, this method may additionally or alternatively be executed by any one system, or any combination of systems, including, but not limited to, those described herein.

FIG. 3 is a flow diagram showing the method 300 for generating assessments related to annotations, according to one or more embodiments of the present disclosure. The method 300, at block B302 may include obtaining assessment annotations corresponding to one or more generated outputs, such as described with respect to FIG. 1. Individual assessment annotations of the assessment annotations may correspond to a respective annotator. Additionally or alternatively, one or more of the annotators may include machine annotators. In these and other embodiments, the generated outputs may include at least one ML output generated by at least one ML model.

Block B304 may include obtaining one or more of a first ground truth annotation or a second ground truth annotation corresponding to one or more of the outputs. In some embodiments, the first ground truth annotation may include a consensus ground truth annotation such as described in the present disclosure. Additionally or alternatively, the second ground truth annotation may include an expert ground truth annotation such as described in the present disclosure.

Block B306 may include determining one or more assessments related to one or more of the assessment annotations based at least on one or more of the first ground truth annotation or the second ground truth annotation. For example, the assessments may include annotation assessments and/or annotator assessments such as described in the present disclosure.

Block B308 may include performing one or more adjustment operations based at least on the one or more assessments. For example, the adjustments may include selecting annotations and/or annotators, generating feedback, modifying machine annotators, modifying outputs based on annotations, etc. such as described in the present disclosure.

Modifications, additions, or omissions may be made to the method 300 without departing from the scope of the present disclosure. For example, although illustrated as discrete blocks, various blocks of the method 300 may be divided into additional blocks, combined into fewer blocks, or eliminated, depending on the particular implementations. Further, in some embodiments the method 300 may be used to perform multiple different assessments and/or adjustments.

### Example Language Models

In at least some embodiments and as discussed in the present disclosure, generative language models, such as large language models (LLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases)—such as millions or billions of parameters. The LLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

Various types of LLMs/VLMs/MMLMs/etc. architectures may be implemented in various embodiments. For example, different architectures may be implemented that use different techniques for understanding and generating outputs-such as text, audio, video, image, 2D and/or 3D design or asset data, etc. In some embodiments, LLMs/VLMs/MMLMs/etc. architectures such as recurrent neural networks (RNNs) or long short-term memory networks (LSTMs) may be used, while in other embodiments transformer architectures-such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/VLMs/MMLMs/etc. may also include one or more diffusion block(s) (e.g., denoisers). The LLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/VLMs/MMLMs/etc. that include both encoder and decoder components like T5 (Text-to-Text Transformer) may be implemented to understand and generate content, such as for translation and summarization. These examples are not intended to be limiting, and any architecture type-including but not limited to those described herein—may be implemented depending on the particular embodiment and the task(s) being performed using the LLMs/VLMs/MMLMs/etc.

In various embodiments, the LLMs/VLMs/MMLMs/etc. may be trained using unsupervised learning, in which an LLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/VLMs/MMLMs/etc., and/or preventing the output or presentation (e.g., display, audio output, etc.) of information generating using the LLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3rd party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources-such as APIs, plug-ins, and/or the like.

In some embodiments, multiple language models (e.g., LLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 4A is a block diagram of an example generative language model system 400 suitable for use in implementing at least some embodiments of the present disclosure. In the example illustrated in FIG. 4A, the generative language model system 400 includes a retrieval augmented generation (RAG) component 492, an input processor 405, a tokenizer 410, an embedding component 420, plug-ins/APIs 495, and a generative language model (LM) 430 (which may include an LLM, a VLM, a multi-modal LM, etc.).

At a high level, the input processor 405 may receive an input 401 comprising text and/or other types of input data (e.g., audio data, video data, image data, sensor data (e.g., LiDAR, RADAR, ultrasonic, etc.), 3D design data, CAD data, universal scene descriptor (USD) data-such as OpenUSD, etc.), depending on the architecture of the generative LM 430 (e.g., LLM/VLM/MMLM/etc.). In some embodiments, the input 401 includes plain text in the form of one or more sentences, paragraphs, and/or documents. Additionally or alternatively, the input 401 may include numerical sequences, precomputed embeddings (e.g., word or sentence embeddings), and/or structured data (e.g., in tabular formats, JSON, or XML). In some implementations in which the generative LM 430 is capable of processing multi-modal inputs, the input 401 may combine text (or may omit text) with image data, audio data, video data, design data, USD data, and/or other types of input data, such as but not limited to those described herein. Taking raw input text as an example, the input processor 405 may prepare raw input text in various ways. For example, the input processor 405 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 405 may remove stopwords to reduce noise and focus the generative LM 430 on more meaningful content. The input processor 405 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 492 (which may include one or more RAG models, and/or may be performed using the generative LM 430 itself) may be used to retrieve additional information to be used as part of the input 401 or prompt. RAG may be used to enhance the input to the LLM/VLM/MMLM/etc. with external knowledge, so that answers to specific questions or queries or requests are more relevant-such as in a case where specific knowledge is required. The RAG component 492 may fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some embodiments, the input 401 may be generated using the query or input to the model (e.g., a question, a request, etc.) in addition to data retrieved using the RAG component 492. In some embodiments, the input processor 405 may analyze the input 401 and communicate with the RAG component 492 (or the RAG component 492 may be part of the input processor 405, in embodiments) in order to identify relevant text and/or other data to provide to the generative LM 430 as additional context or sources of information from which to identify the response, answer, or output 490, generally. For example, where the input indicates that the user is interested in a desired tire pressure for a particular make and model of vehicle, the RAG component 492 may retrieve-using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 492 may retrieve a prior stored conversation history—or at least a summary thereof—and include the prior conversation history along with the current ask/request as part of the input 401 to the generative LM 430.

The RAG component 492 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 492 and the embeddings of the chunks along with the embeddings of the query may be compared to identify the most similar/related embeddings to the query, which may be supplied to the generative LM 430 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/VLM/MMLM/etc. Rather than (or in addition to) providing the model with chunks of data extracted from larger sized documents-which may result in a lack of context, factual correctness, language accuracy, etc.—graph RAG may also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/VLM/MMLM/etc. may summarize the results. In such an example, the graph may strore relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 492 may implement a plugin, API, user interface, and/or other functionality to perform RAG. For example, a graph RAG plug-in may be used by the LLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 410 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 430 to understand morphological variations and handle out-of-vocabulary words more effectively. Character-based tokenization represents each character as a separate token, enabling the generative LM 430 to process text at a fine-grained level. The choice of tokenization strategy may depend on factors such as the language being processed, the task at hand, and/or characteristics of the training dataset. As such, the tokenizer 410 may convert the (e.g., processed) text into a structured format according to tokenization schema being implemented in the particular embodiment.

The embedding component 420 may use any known embedding technique to transform discrete tokens into (e.g., dense, continuous vector) representations of semantic meaning. For example, the embedding component 420 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 401 includes image data/video data/etc., the input processor 401 may resize the data to a standard size compatible with format of a corresponding input channel and/or may normalize pixel values to a common range (e.g., 0 to 1) to ensure a consistent representation, and the embedding component 420 may encode the image data using any known technique (e.g., using one or more convolutional neural networks (CNNs) to extract visual features). In some implementations in which the input 401 includes audio data, the input processor 401 may resample an audio file to a consistent sampling rate for uniform processing, and the embedding component 420 may use any known technique to extract and encode audio features-such as in the form of a spectrogram (e.g., a mel-spectrogram). In some implementations in which the input 401 includes video data, the input processor 401 may extract frames or apply resizing to extracted frames, and the embedding component 420 may extract features such as optical flow embeddings or video embeddings and/or may encode temporal information or sequences of frames. In some implementations in which the input 401 includes multi-modal data, the embedding component 420 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 430 and/or other components of the generative LM system 400 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 420 may apply an encoded representation of the input 401 to the generative LM 430, and the generative LM 430 may process the encoded representation of the input 401 to generate an output 490, which may include responsive text and/or other types of data.

As described herein, in some embodiments, the generative LM 430 may be configured to access or use—or capable of accessing or using-plug-ins/APIs 495 (which may include one or more plug-ins, application programming interfaces (APIs), databases, data stores, repositories, etc.). For example, for certain tasks or operations that the generative LM 430 is not ideally suited for, the model may have instructions (e.g., as a result of training, and/or based on instructions in a given prompt, such as those retrieved using the RAG component 492) to access one or more plug-ins/APIs 495 (e.g., 3rd party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 495 to the plug-in/API 495, the plug-in/API 495 may process the information and return an answer to the generative LM 430, and the generative LM 430 may use the response to generate the output 490. This process may be repeated—e.g., recursively—for any number of iterations and using any number of plug-ins/APIs 495 until an output 490 that addresses each ask/question/request/process/operation/etc. from the input 401 can be generated. As such, the model(s) may not only rely on its own knowledge from training on a large dataset(s) and/or from data retrieved using the RAG component 492, but also on the expertise or optimized nature of one or more external resources-such as the plug-ins/APIs 495.

FIG. 4B is a block diagram of an example implementation in which the generative LM 430 includes a transformer encoder-decoder. For example, assume input text such as “Who discovered gravity” is tokenized (e.g., by the tokenizer 410 of FIG. 4A) into tokens such as words, and each token is encoded (e.g., by the embedding component 420 of FIG. 94A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 435 of the generative LM 430.

In an example implementation, the encoder(s) 435 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 440 may convert the context vector into attention vectors (keys and values) for the decoder(s) 445.

In an example implementation, the decoder(s) 445 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 435, in an example transformer architecture, each token (e.g., word) flows through a separate path in the decoder(s) 445. During a first pass, the decoder(s) 445, a classifier 450, and a generation mechanism 455 may generate a first token, and the generation mechanism 455 may apply the generated token as an input during a second pass. The process may repeat in a loop, successively generating and adding tokens (e.g., words) to the output from the preceding pass and applying the token embeddings of the composite sequence with positional encodings as an input to the decoder(s) 445 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 435, except that it creates its queries from the layer below it and takes the keys and values (e.g., matrix) from the output of the encoder(s) 435.

As such, the decoder(s) 445 may output some decoded (e.g., vector) representation of the input being applied during a particular pass. The classifier 450 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 455 may select or sample a word or token based on a corresponding predicted probability (e.g., select the word with the highest predicted probability) and append it to the output from a previous pass, generating each word or token sequentially. The generation mechanism 455 may repeat the process, triggering successive decoder inputs and corresponding predictions until selecting or sampling a symbol or token that represents the end of the response, at which point, the generation mechanism 455 may output the generated response.

FIG. 4C is a block diagram of an example implementation in which the generative LM 430 includes a decoder-only transformer architecture. For example, the decoder(s) 460 of FIG. 4C may operate similarly as the decoder(s) 445 of FIG. 4B except each of the decoder(s) 460 of FIG. 4C omits the encoder-decoder self-attention layer (since there is no encoder in this implementation). As such, the decoder(s) 460 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 460. As with the decoder(s) 445 of FIG. 4B, each token (e.g., word) may flow through a separate path in the decoder(s) 460, and the decoder(s) 460, a classifier 465, and a generation mechanism 470 may use auto-regression to sequentially generate one token at a time until predicting a symbol or token that represents the end of the response. The classifier 465 and the generation mechanism 470 may operate similarly as the classifier 450 and the generation mechanism 455 of FIG. 4B, with the generation mechanism 470 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Computing Device

FIG. 5 is a block diagram of an example computing device(s) 500 suitable for use in implementing some embodiments of the present disclosure. Computing device 500 may include an interconnect system 502 that directly or indirectly couples the following devices: memory 504, one or more central processing units (CPUs) 506, one or more graphics processing units (GPUs) 508, a communication interface 510, input/output (I/O) ports 512, input/output components 514, a power supply 516, one or more presentation components 518 (e.g., display(s)), and one or more logic units 520. In at least one embodiment, the computing device(s) 500 may comprise one or more virtual machines (VMs), and/or any of the components thereof may comprise virtual components (e.g., virtual hardware components). For non-limiting examples, one or more of the GPUs 508 may comprise one or more vGPUs, one or more of the CPUs 506 may comprise one or more vCPUs, and/or one or more of the logic units 520 may comprise one or more virtual logic units. As such, a computing device(s) 500 may include discrete components (e.g., a full GPU dedicated to the computing device 500), virtual components (e.g., a portion of a GPU dedicated to the computing device 500), or a combination thereof.

Although the various blocks of FIG. 5 are shown as connected via the interconnect system 502 with lines, this is not intended to be limiting and is for clarity only. For example, in some embodiments, a presentation component 518, such as a display device, may be considered an I/O component 514 (e.g., if the display is a touch screen). As another example, the CPUs 506 and/or GPUs 508 may include memory (e.g., the memory 504 may be representative of a storage device in addition to the memory of the GPUs 508, the CPUs 506, and/or other components). As such, the computing device of FIG. 5 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5.

The interconnect system 502 may represent one or more links or busses, such as an address bus, a data bus, a control bus, or a combination thereof. The interconnect system 502 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 506 may be directly connected to the memory 504. Further, the CPU 506 may be directly connected to the GPU 508. Where there is direct, or point-to-point connection between components, the interconnect system 502 may include a PCIe link to carry out the connection. In these examples, a PCI bus need not be included in the computing device 500.

The memory 504 may include any of a variety of computer-readable media. The computer-readable media may be any available media that may be accessed by the computing device 500. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 504 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 500. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 506 may be configured to execute at least some of the computer-readable instructions to control one or more components of the computing device 500 to perform one or more of the methods and/or processes described herein. The CPU(s) 506 may each include one or more cores (e.g., one, two, four, eight, twenty-eight, seventy-two, etc.) that are capable of handling a multitude of software threads simultaneously. The CPU(s) 506 may include any type of processor, and may include different types of processors depending on the type of computing device 500 implemented (e.g., processors with fewer cores for mobile devices and processors with more cores for servers). For example, depending on the type of computing device 500, the processor may be an Advanced RISC Machines (ARM) processor implemented using Reduced Instruction Set Computing (RISC) or an x86 processor implemented using Complex Instruction Set Computing (CISC). The computing device 500 may include one or more CPUs 506 in addition to one or more microprocessors or supplementary co-processors, such as math co-processors.

In addition to or alternatively from the CPU(s) 506, the GPU(s) 508 may be configured to execute at least some of the computer-readable instructions to control one or more components of the computing device 500 to perform one or more of the methods and/or processes described herein. One or more of the GPU(s) 508 may be an integrated GPU (e.g., with one or more of the CPU(s) 506 and/or one or more of the GPU(s) 508 may be a discrete GPU. In embodiments, one or more of the GPU(s) 508 may be a coprocessor of one or more of the CPU(s) 506. The GPU(s) 508 may be used by the computing device 500 to render graphics (e.g., 3D graphics) or perform general purpose computations. For example, the GPU(s) 508 may be used for General-Purpose computing on GPUs (GPGPU). The GPU(s) 508 may include hundreds or thousands of cores that are capable of handling hundreds or thousands of software threads simultaneously. The GPU(s) 508 may generate pixel data for output images in response to rendering commands (e.g., rendering commands from the CPU(s) 506 received via a host interface). The GPU(s) 508 may include graphics memory, such as display memory, for storing pixel data or any other suitable data, such as GPGPU data. The display memory may be included as part of the memory 504. The GPU(s) 508 may include two or more GPUs operating in parallel (e.g., via a link). The link may directly connect the GPUs (e.g., using NVLINK) or may connect the GPUs through a switch (e.g., using NVSwitch). When combined together, each GPU 508 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 506 and/or the GPU(s) 508, the logic unit(s) 520 may be configured to execute at least some of the computer-readable instructions to control one or more components of the computing device 500 to perform one or more of the methods and/or processes described herein. In embodiments, the CPU(s) 506, the GPU(s) 508, and/or the logic unit(s) 520 may discretely or jointly perform any combination of the methods, processes and/or portions thereof. One or more of the logic units 520 may be part of and/or integrated in one or more of the CPU(s) 506 and/or the GPU(s) 508 and/or one or more of the logic units 520 may be discrete components or otherwise external to the CPU(s) 506 and/or the GPU(s) 508. In embodiments, one or more of the logic units 520 may be a coprocessor of one or more of the CPU(s) 506 and/or one or more of the GPU(s) 508.

Examples of the logic unit(s) 520 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 510 may include one or more receivers, transmitters, and/or transceivers that allow the computing device 500 to communicate with other computing devices via an electronic communication network, included wired and/or wireless communications. The communication interface 510 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 520 and/or communication interface 510 may include one or more data processing units (DPUs) to transmit data received over a network and/or through interconnect system 502 directly to (e.g., a memory of) one or more GPU(s) 508.

The I/O ports 512 may allow the computing device 500 to be logically coupled to other devices including the I/O components 514, the presentation component(s) 518, and/or other components, some of which may be built in to (e.g., integrated in) the computing device 500. Illustrative I/O components 514 include a microphone, mouse, keyboard, joystick, game pad, game controller, satellite dish, scanner, printer, wireless device, etc. The I/O components 514 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 500. The computing device 500 may be include depth cameras, such as stereoscopic camera systems, infrared camera systems, RGB camera systems, touchscreen technology, and combinations of these, for gesture detection and recognition. Additionally, the computing device 500 may include accelerometers or gyroscopes (e.g., as part of an inertia measurement unit (IMU)) that allow detection of motion. In some examples, the output of the accelerometers or gyroscopes may be used by the computing device 500 to render immersive augmented reality or virtual reality.

The power supply 516 may include a hard-wired power supply, a battery power supply, or a combination thereof. The power supply 516 may provide power to the computing device 500 to allow the components of the computing device 500 to operate.

The presentation component(s) 518 may include a display (e.g., a monitor, a touch screen, a television screen, a heads-up-display (HUD), other display types, or a combination thereof), speakers, and/or other presentation components. The presentation component(s) 518 may receive data from other components (e.g., the GPU(s) 508, the CPU(s) 506, DPUs, etc.), and output the data (e.g., as an image, video, sound, etc.).

### Example Data Center

FIG. 6 illustrates an example data center 600 that may be used in at least one embodiments of the present disclosure. The data center 600 may include a data center infrastructure layer 610, a framework layer 620, a software layer 630, and/or an application layer 640.

As shown in FIG. 6, the data center infrastructure layer 610 may include a resource orchestrator 612, grouped computing resources 614, and node computing resources (“node C.R.s”) 616(1)-616(N), where “N” represents any whole, positive integer. In at least one embodiment, node C.R.s 616(1)-616(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 616(1)-616(N) may correspond to a server having one or more of the above-mentioned computing resources. In addition, in some embodiments, the node C.R.s 616(1)-6161(N) may include one or more virtual components, such as vGPUs, vCPUs, and/or the like, and/or one or more of the node C.R.s 616(1)-616(N) may correspond to a virtual machine (VM).

In at least one embodiment, grouped computing resources 614 may include separate groupings of node C.R.s 616 housed within one or more racks (not shown), or many racks housed in data centers at various geographical locations (also not shown). Separate groupings of node C.R.s 616 within grouped computing resources 614 may include grouped compute, network, memory or storage resources that may be configured or allocated to support one or more workloads. In at least one embodiment, several node C.R.s 616 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 612 may configure or otherwise control one or more node C.R.s 616(1)-616(N) and/or grouped computing resources 614. In at least one embodiment, resource orchestrator 612 may include a software design infrastructure (SDI) management entity for the data center 600. The resource orchestrator 612 may include hardware, software, or some combination thereof.

In at least one embodiment, as shown in FIG. 6, framework layer 620 may include a job scheduler 628, a configuration manager 634, a resource manager 636, and/or a distributed file system 638. The framework layer 620 may include a framework to support software 632 of software layer 630 and/or one or more application(s) 642 of application layer 640. The software 632 or application(s) 642 may respectively include web-based service software or applications, such as those provided by Amazon Web Services, Google Cloud and Microsoft Azure. The framework layer 620 may be, but is not limited to, a type of free and open-source software web application framework such as Apache Spark™ (hereinafter “Spark”) that may use distributed file system 638 for large-scale data processing (e.g., “big data”). In at least one embodiment, job scheduler 628 may include a Spark driver to facilitate scheduling of workloads supported by various layers of data center 600. The configuration manager 634 may be capable of configuring different layers such as software layer 630 and framework layer 620 including Spark and distributed file system 638 for supporting large-scale data processing. The resource manager 636 may be capable of managing clustered or grouped computing resources mapped to or allocated for support of distributed file system 638 and job scheduler 628. In at least one embodiment, clustered or grouped computing resources may include grouped computing resource 614 at data center infrastructure layer 610. The resource manager 636 may coordinate with resource orchestrator 612 to manage these mapped or allocated computing resources.

In at least one embodiment, software 632 included in software layer 630 may include software used by at least portions of node C.R.s 616(1)-616(N), grouped computing resources 614, and/or distributed file system 638 of framework layer 620. One or more types of software may include, but are not limited to, Internet web page search software, e-mail virus scan software, database software, and streaming video content software.

In at least one embodiment, application(s) 642 included in application layer 640 may include one or more types of applications used by at least portions of node C.R.s 616(1)-616(N), grouped computing resources 614, and/or distributed file system 638 of framework layer 620. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 634, resource manager 636, and resource orchestrator 612 may implement any number and type of self-modifying actions based on any amount and type of data acquired in any technically feasible fashion. Self-modifying actions may relieve a data center operator of data center 600 from making possibly bad configuration decisions and possibly avoiding underutilized and/or poor performing portions of a data center.

The data center 600 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 600. In at least one embodiment, trained or deployed machine learning models corresponding to one or more neural networks may be used to infer or predict information using resources described above with respect to the data center 600 by using weight parameters calculated through one or more training techniques, such as but not limited to those described herein.

In at least one embodiment, the data center 600 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 500 of FIG. 5—e.g., each device may include similar components, features, and/or functionality of the computing device(s) 500. In addition, where backend devices (e.g., servers, NAS, etc.) are implemented, the backend devices may be included as part of a data center 600, an example of which is described in more detail herein with respect to FIG. 6.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 500 described herein with respect to FIG. 5. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

The subject technology of the present disclosure is illustrated, for example, according to various aspects described below. Various examples of aspects of the present disclosure are described as numbered examples (1, 2, 3, etc.) for convenience. These are provided as examples and do not limit the present disclosure. The aspects of the various implementations described herein may be omitted, substituted for aspects of other implementations, or combined with aspects of other implementations unless context dictates otherwise. For example, one or more aspects of example 1 below may be omitted, substituted for one or more aspects of another example (e.g., example 2) or examples, or combined with aspects of another example The following is a non-limiting summary of some example implementations presented herein.

Example 1: A method comprising:
obtaining a plurality of assessment annotations corresponding to a machine learning output of a machine learning model, individual assessment annotations of the plurality of assessment annotations corresponding to a respective annotator;
determining a first ground truth annotation corresponding to the machine learning output based at least on the plurality of assessment annotations;
obtaining a second ground truth annotation corresponding to the machine learning output, the second ground truth annotation corresponding to an expert related to the machine learning output;
determining one or more assessments related to one or more assessment annotations of the plurality of assessment annotations based at least on one or more of the first ground truth annotation or the second ground truth annotation, at least one assessment of the one or more assessments corresponding to a machine-learning based annotator in which the machine-learning based annotator is modified based at least on an assessment corresponding thereto.

Example 2: The method of Example 1, wherein the first ground truth annotation is based at least on one or more of:
a majority of the plurality of assessment annotations; or
a highest number of assessment annotations of the plurality of assessment annotations.

Example 3: The method of Example 1, wherein at least one assessment of the one or more assessments corresponds to a human annotator.

Example 4: The method of Example 3, wherein annotation feedback is provided to the human annotator based at least on the at least one assessment corresponding to the human annotator.

Example 5: The method of Example 1, further comprising selecting at least one annotator of the plurality of annotators for generating one or more assessment annotations with respect to one or more other machine learning outputs based at least on at least one evaluation assessments that respectively correspond to the at least one annotator.

Example 6: The method of Example 1, wherein the machine-learning model based annotator includes a generative language model (GLM).

Example 7: The method of Example 1, wherein at least one assessment of the plurality of assessments includes an accuracy assessment that indicates a level of accuracy of an individual assessment annotation with respect to one or more of the first ground truth annotation or the second ground truth annotation.

Example 8: The method of Example 1, wherein at least one assessment of the plurality of assessments includes a reliability metric that indicates a level of consistency of particular assessment annotations that correspond to a particular annotator.

Example 9: The method of Example 8, wherein the reliability metric is based at least on respective determined distances between the particular assessment annotations and one or more of the first ground truth annotation or the second ground truth annotation.

Example 10: The method of Example 1, wherein the assessments include one or more annotator assessments respectively corresponding to one or more annotators of the plurality of annotators, the one or more annotator assessments for the one or more annotators being based at least on the assessments corresponding to the one or more annotators.

Example 11: The method of Example 10, wherein the one or more annotator assessments include one or more of:
an annotator accuracy assessment that indicates a level of accuracy of assessment annotations of a respective annotator of the one or more annotators; or
an annotator reliability metric that indicates a level of consistency of the assessment annotations of the respective annotator.

Example 12: A system comprising:
one or more processors to perform operations comprising:
   obtaining a plurality of assessment annotations corresponding to one or more generated outputs, individual assessment annotations of the plurality of assessment annotations corresponding to a respective annotator;
   obtaining one or more of:
      a first ground truth annotation corresponding to the one or more generated outputs based at least on the plurality of assessment annotations; or
      a second ground truth annotation corresponding to the one or more generated outputs, the second ground truth annotation corresponding to an expert related to the one or more generated outputs;
   determining one or more assessments related to one or more assessment annotations of the plurality of assessment annotations based at least on one or more of the first ground truth annotation or the second ground truth annotation; and
   performing one or more adjustment operations based at least on the one or more assessments.

Example 13: The system of Example 12, wherein the one or more generated outputs includes a machine learning output.

Example 14: The system of Example 12, wherein:
at least one assessment of the one or more assessments corresponds to a machine-learning based annotator; and
the one or more adjustment operations include modifying the machine-learning based annotator based at least on the at least one assessment corresponding to the machine-learning based annotator.

Example 15: The system of Example 12, wherein the first ground truth annotation is based at least on one or more of:
a majority of the plurality of assessment annotations; or
a highest number of assessment annotations of the plurality of assessment annotations.

Example 16: The system of Example 12, wherein at least one assessment of the plurality of assessments includes an accuracy assessment that indicates a level of accuracy of an individual annotation with respect to one or more of the first ground truth annotation or the second ground truth annotation.

Example 17: The system of Example 12, wherein at least one assessment of the plurality of assessments includes a reliability assessment that indicates a level of consistency of particular assessment annotations that correspond to a particular annotator.

Example 18: The system of Example 12, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for presenting at least one of augmented reality content, virtual reality content, or mixed reality content;
a system for hosting one or more real-time streaming applications;
a system implemented using an edge device;
a system implemented using a robot;
a system for performing conversational AI operations;
a system for performing one or more generative AI operations;
a system implementing one or more large language models (LLMs);
a system implementing one or more vision language models (VLMs);
a system implementing one or more multi-modal language models;
a system for generating synthetic data;
a system incorporating one or more virtual machines (VMs);
a system implemented at least partially in a data center; or a system implemented at least partially using cloud computing resources.

Example 19: One or more processors comprising:
processing circuitry to perform operations comprising:
   obtaining one or more of:
      a first ground truth annotation corresponding to one or more generated outputs based at least on a plurality of assessment annotations; or
      a second ground truth annotation corresponding to the one or more generated outputs, the second ground truth annotation corresponding to an expert related to the one or more generated outputs;
   determining one or more assessments related to one or more assessment annotations of the plurality of assessment annotations based at least on one or more of the first ground truth annotation or the second ground truth annotation; and
   performing one or more adjustment operations based at least on the one or more assessments.

Example 20: The one or more processors of Example 19, wherein at least one assessment of the plurality of assessments includes one or more of:
an accuracy assessment that indicates a level of accuracy of an individual annotation with respect to one or more of the first ground truth annotation or the second ground truth annotation; or
a reliability assessment that indicates a level of consistency of particular assessment annotations that correspond to a particular annotator.

The following is claimed:

1. A method comprising:
obtaining a plurality of assessment annotations corresponding to a machine learning output of a machine learning model, individual assessment annotations of the plurality of assessment annotations corresponding to a respective annotator;
determining a first ground truth annotation corresponding to the machine learning output based at least on the plurality of assessment annotations;
obtaining a second ground truth annotation corresponding to the machine learning output, the second ground truth annotation corresponding to an expert related to the machine learning output;
determining one or more assessments related to one or more assessment annotations of the plurality of assessment annotations based at least on one or more of the first ground truth annotation or the second ground truth annotation, at least one assessment of the one or more assessments corresponding to a machine-learning based annotator in which the machine-learning based annotator is modified based at least on an assessment corresponding thereto.

2. The method of claim 1, wherein the first ground truth annotation is based at least on one or more of:
a majority of the plurality of assessment annotations; or
a highest number of assessment annotations of the plurality of assessment annotations.

3. The method of claim 1, wherein at least one assessment of the one or more assessments corresponds to a human annotator.

4. The method of claim 3, wherein annotation feedback is provided to the human annotator based at least on the at least one assessment corresponding to the human annotator.

5. The method of claim 1, further comprising selecting at least one annotator of the plurality of annotators for generating one or more assessment annotations with respect to one or more other machine learning outputs based at least on at least one evaluation assessments that respectively correspond to the at least one annotator.

6. The method of claim 1, wherein the machine-learning model based annotator includes a generative language model (GLM).

7. The method of claim 1, wherein at least one assessment of the plurality of assessments includes an accuracy assessment that indicates a level of accuracy of an individual assessment annotation with respect to one or more of the first ground truth annotation or the second ground truth annotation.

8. The method of claim 1, wherein at least one assessment of the plurality of assessments includes a reliability metric that indicates a level of consistency of particular assessment annotations that correspond to a particular annotator.

9. The method of claim 8, wherein the reliability metric is based at least on respective determined distances between the particular assessment annotations and one or more of the first ground truth annotation or the second ground truth annotation.

10. The method of claim 1, wherein the assessments include one or more annotator assessments respectively corresponding to one or more annotators of the plurality of annotators, the one or more annotator assessments for the one or more annotators being based at least on the assessments corresponding to the one or more annotators.

11. The method of claim 10, wherein the one or more annotator assessments include one or more of:
an annotator accuracy assessment that indicates a level of accuracy of assessment annotations of a respective annotator of the one or more annotators; or
an annotator reliability metric that indicates a level of consistency of the assessment annotations of the respective annotator.

12. A system comprising:
one or more processors to perform operations comprising:
obtaining a plurality of assessment annotations corresponding to one or more generated outputs, individual assessment annotations of the plurality of assessment annotations corresponding to a respective annotator;
obtaining one or more of:
a first ground truth annotation corresponding to the one or more generated outputs based at least on the plurality of assessment annotations; or
a second ground truth annotation corresponding to the one or more generated outputs, the second ground truth annotation corresponding to an expert related to the one or more generated outputs;
determining one or more assessments related to one or more assessment annotations of the plurality of assessment annotations based at least on one or more of the first ground truth annotation or the second ground truth annotation; and
performing one or more adjustment operations based at least on the one or more assessments.

13. The system of claim 12, wherein the one or more generated outputs includes a machine learning output.

14. The system of claim 12, wherein:
at least one assessment of the one or more assessments corresponds to a machine-learning based annotator; and
the one or more adjustment operations include modifying the machine-learning based annotator based at least on the at least one assessment corresponding to the machine-learning based annotator.

15. The system of claim 12, wherein the first ground truth annotation is based at least on one or more of:
a majority of the plurality of assessment annotations; or
a highest number of assessment annotations of the plurality of assessment annotations.

16. The system of claim 12, wherein at least one assessment of the plurality of assessments includes an accuracy assessment that indicates a level of accuracy of an individual annotation with respect to one or more of the first ground truth annotation or the second ground truth annotation.

17. The system of claim 12, wherein at least one assessment of the plurality of assessments includes a reliability assessment that indicates a level of consistency of particular assessment annotations that correspond to a particular annotator.

18. The system of claim 12, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for presenting at least one of augmented reality content, virtual reality content, or mixed reality content;
a system for hosting one or more real-time streaming applications;
a system implemented using an edge device;
a system implemented using a robot;
a system for performing conversational AI operations;
a system for performing one or more generative AI operations;
a system implementing one or more large language models (LLMs);
a system implementing one or more vision language models (VLMs);
a system implementing one or more multi-modal language models;
a system for generating synthetic data;
a system incorporating one or more virtual machines (VMs);
a system implemented at least partially in a data center; or
a system implemented at least partially using cloud computing resources.

19. One or more processors comprising:
processing circuitry to perform operations comprising:
obtaining one or more of:
a first ground truth annotation corresponding to one or more generated outputs based at least on a plurality of assessment annotations; or
a second ground truth annotation corresponding to the one or more generated outputs, the second ground truth annotation corresponding to an expert related to the one or more generated outputs;
determining one or more assessments related to one or more assessment annotations of the plurality of assessment annotations based at least on one or more of the first ground truth annotation or the second ground truth annotation; and
performing one or more adjustment operations based at least on the one or more assessments.

20. The one or more processors of claim 19, wherein at least one assessment of the plurality of assessments includes one or more of:
an accuracy assessment that indicates a level of accuracy of an individual annotation with respect to one or more of the first ground truth annotation or the second ground truth annotation; or
a reliability assessment that indicates a level of consistency of particular assessment annotations that correspond to a particular annotator.
